(19) United States
(12) Patent Application Publication
(10) Pub. No.: US 2020/0307087 A1
(43) Pub. Date: Oct. 1, 2020

(54) THERMALLY MATCHED STEP BUILD SUBSTRATE

(71) Applicant: Evolve Additive Solutions, Inc., Minnetonka, MN (US)

(72) Inventors: Chris Counts, Crystal, MN (US); J. Samuel Batchelder, Somers, NY (US)

(21) Appl. No.: 16/796,518

(22) Filed: Feb. 20, 2020

Related U.S. Application Data
(60) Provisional application No. 62/808,720, filed on Feb. 21, 2019.

(51) Int. Cl. B29C 64/245; B33Y 10/00; B33Y 30/00

(52) U.S. Cl. CPC B29C 64/245; B33Y 10/00; B29K 2995/0012; B29K 2863/00; B33Y 30/00

(57) ABSTRACT

Embodiments herein relate to substrates for use in a selective toner electrophotographic process (STEP) additive manufacturing system. The substrates include a build platform for use in STEP additive manufacturing system, the build platform comprising a build substrate for receiving a build material deposited by a STEP process; wherein the platform has selected thermal properties, such as within 30 percent of the build material to be deposited onto the substrate.

This application claims the benefit of U.S. Provisional Application No. 62,808,720, filed Feb. 21, 2019, the content of which is herein incorporated by reference in its entirety.

### FIELD

Embodiments herein relate to build substrates for selective toner electrophotographic processes.

### BACKGROUND

The present disclosure relates to additive manufacturing systems for building three-dimensional (3D) parts and support structures. In particular, the present disclosure relates to additive manufacturing systems and processes for building 3D parts and support structures using an imaging process, such as electrophotography.

Additive manufacturing systems are used to build 3D parts from digital representations of the parts using one or more additive manufacturing techniques. Examples of commercially available additive manufacturing techniques include extrusion-based techniques, ink jetting, selective laser sintering, powder/binder jetting, electron beam melting, and stereolithographic processes. For each of these techniques, the digital representation of the 3D part is initially sliced into multiple horizontal layers. A tool path is then generated for each sliced layer, which provides instructions for the particular additive manufacturing system to form the given layer.

For example, in an extrusion-based additive manufacturing system, a 3D part or model may be printed from a digital representation of the 3D part in a layer-by-layer manner by extruding a flowable part material. The part material is extruded through an extrusion tip carried by a print head of the system, and this part material is deposited on a substrate in an x-y plane. The extruded part material fuses to previously deposited part material and solidifies upon a drop in temperature. The position of the print head relative to the substrate is then incrementally moved along a z-axis (perpendicular to the x-y plane), and the process is then repeated to form a 3D part resembling the digital representation.

Another type of 3D manufacturing system is selective toner electrophotographic process (STEP) additive manufacturing. In STEP layers of thermoplastic material are carried from electrophotography (EP) engine by a transfer medium (e.g., a rotatable belt or drum). The layers are then transferred to a build platform to print the 3D part (or support structure) in a layer-by-layer manner, where the successive layers are transfused together to produce the 3D part (or support structure). The layers that are deposited can include build material that will form the finished part, as well as support material that will be removed (such as being dissolved) to make the finished part. Also, portions of each layer are typically voids that are free of build material or support material.

During STEP processing it is necessary to heat the thermoplastic material to an elevated temperature so that it will transfer from the transfer medium to a substrate (such as a partially formed part). It is important that the substrate temperature be kept within a desired range. It should be hot enough to promote transfusion, but not so hot that it easily deforms. Excessive heat can interfere with the transfusion process and can cause problems if the partially formed part becomes too hot. Those problems can include, for example, deformation of the overheated part.

Therefore, a need exists for improvements to STEP manufacturing processes, including changes that improve upon the temperature regulation of the part being formed, including the temperature of the build substrate on which it is formed.

### SUMMARY

An aspect of the present disclosure is directed to an additive manufacturing system for creating a 3D part, in particular selective toner electrophotographic process (STEP) additive manufacturing. In an example implementation the additive manufacturing system includes an imaging engine configured to develop an imaged layer of a thermoplastic-based powder, a movable build platform containing a build substrate, and a transfer medium (e.g., a rotatable belt or drum) configured to receive the imaged layer from the imaging engine and to convey the received imaged layer to the build substrate on the build platform. Multiple imaged layers are built up to form a 3D part on the build substrate.

The system also includes a transfusion assembly configured to transfer the heated imaged layer conveyed by the transfer medium onto the movable build platform by pressing the heated imaged layer between the transfer medium and the moveable build platform, and a cooling unit configured to actively cool the transferred layer.

In an example embodiment a build substrate for use in a STEP additive manufacturing system includes a top surface for receiving a build material deposited by a STEP process wherein the build substrate has selected thermal properties that are close to the thermal properties of the material being deposited. For example, in some constructions the build substrate has selected thermal properties that are within 30 percent of the build material to be deposited onto the platform. In some constructions the build substrate has selected thermal properties within 20 percent of the build material to be deposited onto the platform. In various constructions the build substrate has selected thermal properties within 10 percent of the build material to be deposited onto the platform.

In some embodiments the build substrate for the STEP manufacturing process comprises a laminate, such as a fiber-reinforced laminate that provides strength and thermal stability. For example, in an embodiment the substrate comprises a glass-reinforced epoxy laminate material. When a fiber-reinforced resin material is used, generally both the fiber and resin are selected to provide durability while also offering strength to support the building of a part and favorable thermal properties. For example, optionally the build substrate comprises National Electrical Manufacturers Association (NEMA) FR-4 material, which is a composite material composed of woven fiberglass cloth and an epoxy resin binder that is flame resistant. FR-4 material is known to retain its high mechanical values and electrical insulating qualities in various conditions, and has good fabrication characteristics.

The build substrate can be selected on the basis of heat absorption, and in some constructions has a heat absorption rate within 30 percent of a partially completed part formed of the build material. The build substrate can also be selected on the basis of heat capacity Cp, and in example embodiments the build substrate has a heat capacity Cp within 30 percent of a partially completed part formed of the build material. The build substrate can also be picked on the basis of thermal diffusivity K, and in an example embodiment the build substrate has a thermal diffusivity K within 30 percent of a partially completed part formed of the build material. The build substrate can also be selected based upon thermal conductivity K, and in an example embodiment has a thermal conductivity K within 30 percent of a partially completed part formed of the build material.

In an example embodiment the thickness of the build substrate is within at least three thermal diffusion lengths at the layer rate of the STEP process. In some constructions the build substrate is constructed such that the fraction η pre-heat illumination absorbed by the build substrate is within 20 percent of the fraction η of pre-heat illumination absorbed by the build material.

In some embodiments the thermal expansion coefficient (TEC) of the build substrate is at least 50 um/(m deg C.) different than the thermal expansion coefficient (TEC) of the build material.

Optionally the build substrate can include one or more temperature sensors in the surface of the build substrate. Such temperature sensors can be, for example, thin conductive traces, such as copper traces. The temperature of the build substrate can be measured, for example, by resistance using a wheatstone bridge. In some embodiments the temperature response of the temperature sensor or sensors is within 1 msec.

Optionally the build substrate further includes an embedded processor, power source, cooling, wireless communication capability, and combinations thereof. The build substrate can also include one or more pressure sensors, shear force sensors, accelerometers, capacitive sensors, or combinations thereof.

In typical embodiments the substrate has a thickness of at least the bulk temperature depth. For example, in some constructions the substrate has a thickness of at least 63 mils.

In some constructions the build substrate is two-parts: a) a removable top portion containing a surface for deposition of build material and containing sensors; and b) a base portion configured to receive the top removable portion, the base portion having electrical connectors to the top portion, and also optionally containing an embedded processor, power source, cooling, wireless communication capability, and combinations thereof.

A method for building an article using a selective toner electrophotographic process (STEP) additive manufacturing system is also disclosed, the method comprising providing the build substrate for receiving a build material deposited by a STEP process;

wherein the platform has selected thermal properties within 30 percent of the build material to be deposited onto the platform; and building an article on the build substrate while controlling the thermal properties of the build substrate.

This summary is an overview of some of the teachings of the present application and is not intended to be an exclusive or exhaustive treatment of the present subject matter. Further details are found in the detailed description and appended claims. Other aspects will be apparent to persons skilled in the art upon reading and understanding the following detailed description and viewing the drawings that form a part thereof, each of which is not to be taken in a limiting sense. The scope herein is defined by the appended claims and their legal equivalents.

### BRIEF DESCRIPTION OF THE FIGURES

Aspects may be more completely understood in connection with the following figures (FIGS.), in which:

FIG. 1 is a schematic illustration of an electrophotography-based additive manufacturing system of the present disclosure.

FIG. 2 is a perspective view of a build platform for receiving a material deposited in a selective toner electrophotographic process (STEP).

FIG. 3A is a top perspective view of a build platform containing a build substrate for a STEP additive manufacturing process.

FIG. 3B is a bottom perspective view of the build substrate for a STEP additive manufacturing process of FIG. 3A.

FIG. 4A is a top plan view of a build substrate for a STEP additive process showing a substrate with an example layout of various temperature sensing regions.

FIG. 4B is a top plan view of a build substrate for a STEP additive process showing a substrate with an example layout of various temperature sensing regions.

FIG. 5A is a schematic diagram of the outline of metallic tracing of a portion of a resistive temperature detector for a temperature sensing region.

FIG. 5B is a schematic diagram of the outline of an alternative metallic tracing of a portion of a resistive temperature detector for a temperature sensing region.

FIG. 6A is a cross section of a first build substrate for a STEP additive manufacturing process.

FIG. 6B is a cross section of a second build substrate for a STEP additive manufacturing process.

FIG. 6C is a cross section of a third build substrate for STEP additive manufacturing process.

While embodiments are susceptible to various modifications and alternative forms, specifics thereof have been shown by way of example and drawings, and will be described in detail. It should be understood, however, that the scope herein is not limited to the particular aspects described. On the contrary, the intention is to cover modifications, equivalents, and alternatives falling within the spirit and scope herein.

### DETAILED DESCRIPTION

During STEP processing it is necessary to heat the thermoplastic material to an elevated temperature so that it will transfer from the transfer medium to a substrate (such as a partially formed part). It is important that the substrate temperature be kept within a desired range, and also that the substrate have thermal properties that promote good STEP performance. The build substrate onto which build and support material is deposited should be hot enough to promote transfusion, but not so hot that it easily deforms. Also, excessive heat can interfere with the transfusion process and can cause problems if the partially formed part becomes too hot. Those problems can include, for example, deformation of the overheated part. Therefore, thermal properties of the build substrate are important, and the build substrate should be constructed to provide desirable performance properties. This construction can include selection of proper substrate materials, dimensions (e.g. thickness) of the substrate, temperature monitoring (such as by integrated temperature sensors), and support of the substrate (such as secondary layers beneath the build substrate).

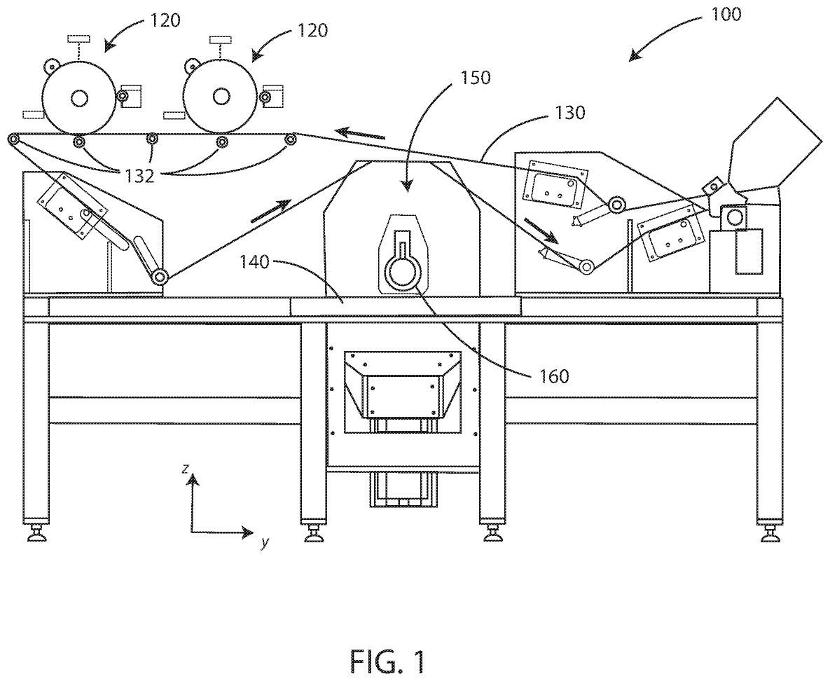

Basic STEP printing systems will now be discussed. Referring to FIG. 1, a simplification of STEP printing system 100 is shown in schematic form, the system 100 is an example additive manufacturing system for printing 3D parts and support structures using electrophotography (EP), which incorporates a layer transfer technique. In the example embodiment system 100 includes electrophotographic (“EP”) engines 120, transfer belt 130, rollers 132, build platform 140 (containing a build substrate on its top surface) and transfusion assembly 150 including nip roller 160 for printing 3D parts (e.g., 3D part) and any associated support structures (not shown). Examples of suitable components and functional operations for system 100, without limitation, include those disclosed in U.S. Pat. Nos. 8,879,957 and 8,488,994.

In alternative embodiments, system 100 may include different imaging engines and transfer components for imaging the layers. The layer transfer technique focuses on the transfer of layers from belt 130 (or other transfer medium) to a build substrate on platform 140 (or to the top layer on the 3D part being printed on build platform 140) at a nip formed between the roller 160 and the platform 140.

System 100 also includes a controller, which is one or more control circuits, microprocessor-based engine control systems, and/or digitally-controlled raster imaging processor systems, and which is configured to operate the components of system 100 in a synchronized manner based on printing instructions received from a host computer. A host computer is one or more computer-based systems configured to communicate with controller to provide the print instructions (and other operating information). For example, a host computer may transfer information that relates to the sliced layers of 3D part (and any support structures), thereby allowing system 100 to print 3D part in a layer-by-layer manner.

Each EP engine 120 (of which there can be one or more) is configured to develop or otherwise image successive layers of a thermoplastic based powder using electrophotography. The thermoplastic-based powder includes one or more thermoplastic materials (such as an acrylonitrile-butadiene-styrene (ABS) copolymer), and may also include one or more additional components for development with EP engine 120 and electrostatic attraction to belt 130. The imaged layers of the thermoplastic-based powder are then rotated to a first transfer region in which layers are transferred from EP engine 120 to belt 130. Belt 130 is an example transfer medium for transferring or otherwise conveying the imaged layers from EP engine 120 to build platform 140. In some embodiments belt 130 may be a multiple layer belt with a low-surface-energy film.

System 100 may also include one or more biasing mechanisms, which are configured to induce an electrical potential through belt 130 to electrostatically attract layers of the thermoplastic based powder from EP engine 120 to belt 130. Because layers of the thermoplastic are each typically only a single layer increment in thickness at this point in the process, electrostatic attraction is suitable for transferring layers from EP engine 120 to belt 130. However the multiple printed layers for 3D part effectively prevents electrostatic transfer of layers from belt 130 to build platform 140 after a given number of layers are printed, therefore electrostatic transfer works for transferring layers of thermoplastic material to the belt 130, but generally does not have a major role in transferring electrostatic material to the build platform 140 or to partially manufactured parts.

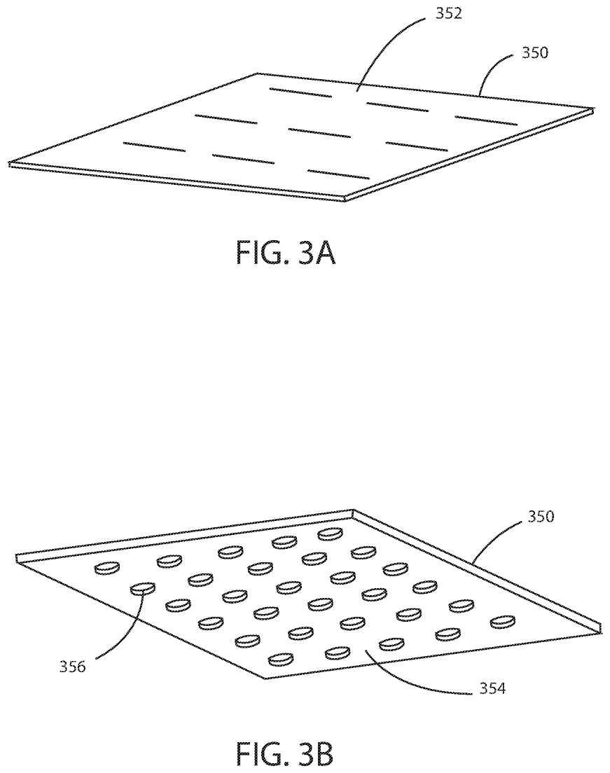

Rollers, such as a series of drive and/or idler rollers or pulleys, can be configured to maintain tension on belt 130 while belt 130 rotates in the rotational directional of arrows shown in FIG. 1. This allows belt 130 to maintain a substantially planar orientation when engaging build platform 140. System 100 may also include various service loops, such as those disclosed in U.S. Pat. No. 8,488,994. Build platform 140, roller 160, and heating any heating assembly (see FIGS. 3 to 14) may collectively be referred to as layer transfusion assembly. Layer transfusion assembly 150 is configured to transfuse the heated layers of thermoplastic material from the belt 130 to the previously-transfused layers of a 3D part (or onto the build substrate on the top of build platform 140) in a layer-by-layer manner.

Build platform 140 is a platform assembly or platen of system 100 that is configured to receive the heated layers of thermoplastic material for printing 3D part in a layer-by-layer manner. Build platform 140 is (in an example configuration) supported by a gantry, which is a linear guide mechanism configured to incrementally lower build platform 140 along the vertical z-axis relative to belt 130 after each pressing step. The movement of build platform 140 with gantry is operated by a z-axis motor. The top surface of the build platform 140 generally includes a substrate formed material selected to provide desired properties, including thermal properties (conductivity, etc.) and material release properties. In some embodiments build platform 140 may include removable film substrates for receiving the printed layers.

The build platform 140 is optionally heatable with a heating element (e.g., an electric heater). The heating element can be configured to heat and maintain the build platform 140 at an elevated temperature that is greater than room temperature (25 degrees Celsius), such as at the desired average part temperature of a 3D part that is being created. This allows build platform 140 to assist in maintaining 3D part at this average part temperature.

The average part temperature for the 3D part is desirably high enough to promote interlayer adhesion and to reduce the effects of curling, while also being low enough to prevent the 3D part from softening too much (i.e., below its deformation temperature). Suitable average part temperatures for 3D parts range from greater than the average solidification temperature of the thermoplastic material(s) of the thermoplastic-based powder to about the glass transition temperature of the thermoplastic material(s). More desirably, the average part temperature is maintained at about the creep relaxation temperature of the thermoplastic material(s) of the thermoplastic-based powder, or within about 10 degrees Celsius above or below thereof. Examples of suitable techniques for determining the creep relaxation temperatures of materials are disclosed in Batchelder et al., U.S. Pat. No. 5,866,058.

In some preferred embodiments, the average part temperature is maintained in a range between the creep relaxation temperature of the thermoplastic material(s) of the thermoplastic-based powder and a maximum allowable solidification temperature, where the maximum allowable solidification temperature may be illustrated by the stress relaxation of the thermoplastic-based powder. For example, when printing layers of an ABS copolymer-based powder, the average part temperature for 3D part may be about 100 degrees Celsius, as may be appreciated by a comparison of the stress relaxation or Young's modulus versus temperature for the composition.

As such, maintaining a 3D part at an average part temperature below the Young's modulus drop for its composition allows 3D part to maintain its structural integrity when pressed between build platform 140 and roller nip during subsequent transfusion steps. Furthermore, when the top-most layer of a 3D part is maintained at this temperature and receives a heated layer at a fusion temperature of about 200 degrees Celsius, the transfusion interface temperature for transfusing the layers together starts at about 150 degrees Celsius.

As mentioned above, the particular pressure applied during each transfusion step is desirably high enough to adhere the heated layer to the previously-transfused layer (or to build platform 140), allowing the polymer molecules to at least partially interdiffuse.

System 100 may also include one or more air knives or other cooling units, where an air knife is an example cooling unit configured to blow localized cooling air to the top layers of 3D part. The air knife can be located adjacent to the lateral side of build platform 140 to direct the cooling air laterally relative to the direction of movement of belt 130. This allows the air knife to extend along the entire length of the 3D part, providing good air flow over the top layers of 3D part, including the fused layer.

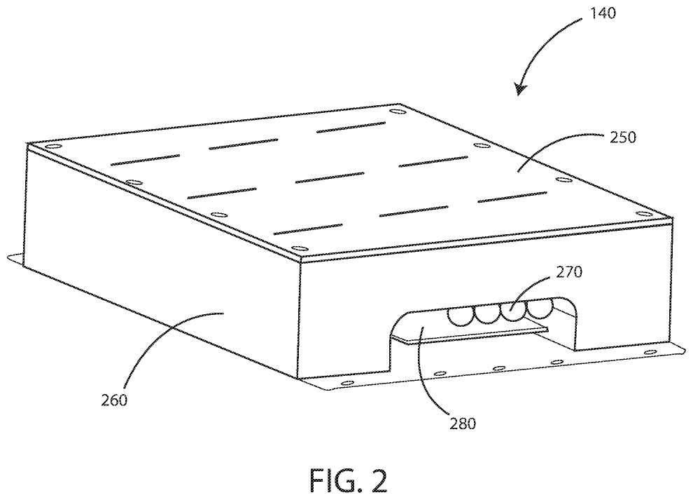

FIG. 2 is a perspective view of a build platform 140 for receiving a material deposited in a selective toner electrophotographic process (STEP). In the depicted embodiment the build platform 140 includes a build substrate 250 positioned on a base 260. The build substrate 250 is typically secured to the base 260, such as by screws or other fasteners. Generally the build substrate 250 is planar or substantially planar, and as described above and below it is generally selected on the basis of thermal properties, and often includes heating elements and temperature sensors for regulating temperature at the top of the build substrate.

In this example build platform 140 shows a portion of a battery pack or other energy storage element 270 (such as an ultra capacitor) and control board 280 depicted (and partly revealed) within the base 260. The energy storage element 270 can provide energy for powering control elements (such as temperature monitoring and reporting), as well as to provide energy to heat portions of the top substrate 250. The base depicted is an example construction, and it will be appreciated that various alternative base constructions are possible, including different shapes, sizes, heights, widths, lengths, proportions, etc. Also, other aspects of the build platform 140 are not shown, such as means for moving and aligning the build platform 140 and build substrate 250, and maintaining the alignment of the build platform 140 and build substrate 250.

In some implementations the build substrate is permanently joined to the base, while in other implementations the build substrate is removable. FIGS. 3A and 3B show views of an example removable build substrate. FIG. 3A is a top perspective view of a removable build substrate 350 for a STEP additive manufacturing process showing top surface 352; and FIG. 3B is a bottom perspective view of the build substrate 350 for a STEP additive manufacturing process showing bottom surface 354 and connectors 356. The connectors 356, show in simplified form, can be used to provide a mechanical connection to a base (not shown) but can also provide an electrical connection for the delivery of electricity for heating the build substrate 350 but also for connecting to temperature sensors in the build substrate 350. This removable build substrate 350 design can be useful for construction of particularly large parts, in which case the build substrate 350 is removable from a base (not shown). Also, this design can be useful for situations where post-printing processing (such as removal of support material) is best performed separately from the base.

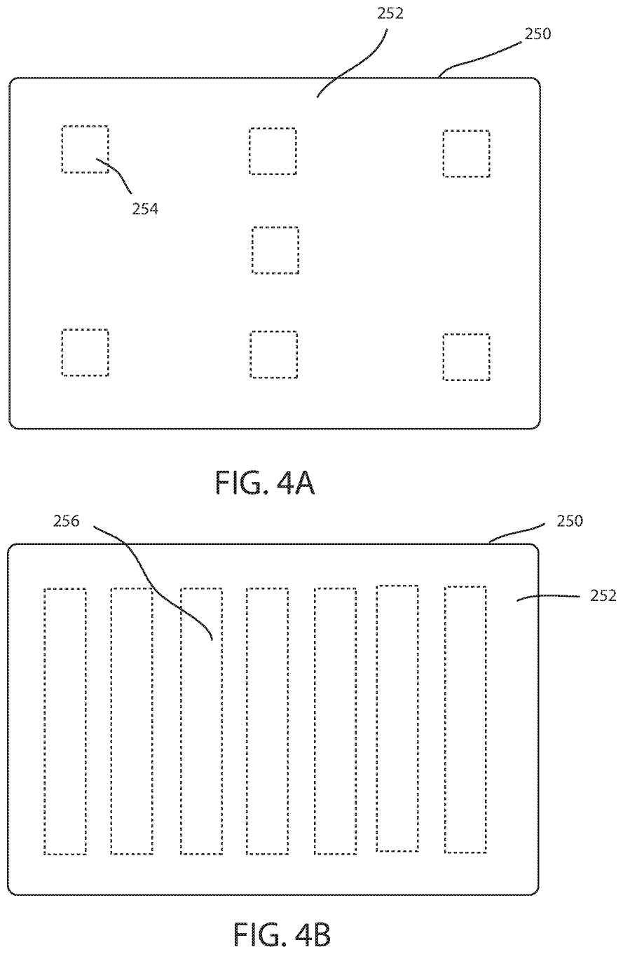

It is often desirable to monitor the temperature of the build substrate, and this can be done using sensors integrated into the build substrate. The sensors can include, for example conductive tracings. The layout of the temperature sensors can take on a variety of configurations. For example in the simplest of implementations a single temperature sensor is positioned within each build substrate. This single temperature sensor can be, for example, very localized such as at the center of the build substrate, or can be a larger sensor that measures average temperature across a large area. However, in general, it is desirable to have relatively precise measures of temperature that are both accurate as well as rapid in terms of measurement so as to capture quickly, real time, precise temperature measurements. The capture of quick, accurate, temperature measurements is useful so as to allow rapid adjustment of build properties. For example, knowing the real-time temperature of the build substrate allows for careful adjustment of any heating from heater elements within the substrate, and also allow for adjustment of heat delivery during the transfusion process (such as increases or decreases in temperature) and also control of cooling after the transfusion step. Also, in some implementations heating and cooling of the substrate can be varied by region on the substrate, and therefore precise temperature monitoring is helpful. Thus, in some implementations multiple temperature sensors are used, and the size and location of these temperature sensors can be varied. Two example configurations for temperature sensor locations are shown in FIGS. 4A and 4B. These examples are shown to indicate examples of various sensor positions as opposed to being limiting. FIG. 4A is a top plan view of a build substrate 250 for a STEP additive process showing a substrate with multiple temperature sensing regions 254 in top surface 252. In this construction a single sensing region 254 is positioned near the center of the of the build substrate 250, while six other sensing regions 254 are positioned along the periphery of the build substrate 250. FIG. 4B is a top plan view of an alternative build substrate 250 for a STEP additive process showing a substrate with temperature sensing regions 256, in top surface 252, covering different areas of the top surface 252 of the build substrate 250 with different sized sensing regions. This construction emphasizes denser sensing areas near the center of the build substrate 250, where parts can be most likely to be formed, as well as numerous sensors from left to right to allow for precise measurement as the build substrate 250 moves through the transfusion and cooling steps.

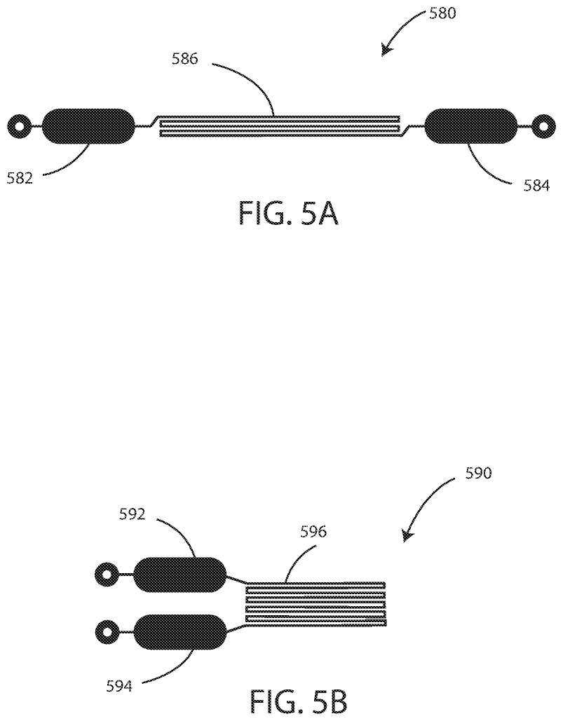

Various types of sensors can be used for measuring temperature, such as example resistive temperature detectors formed from metal tracings shown in FIGS. 5A and 5B, which can be incorporated into wheatstone bridges for temperature measurement. FIG. 5A is a schematic diagram of the outline of metallic tracing 580 of a portion of a resistive temperature detector for a temperature sensing region, showing contacts 582, 584 along with tracing 586. FIG. 5B is a schematic diagram of the outline of metallic tracing 590 of a portion of a resistive temperature detector for a temperature sensing region, showing contacts 592, 594 along with tracings 596.

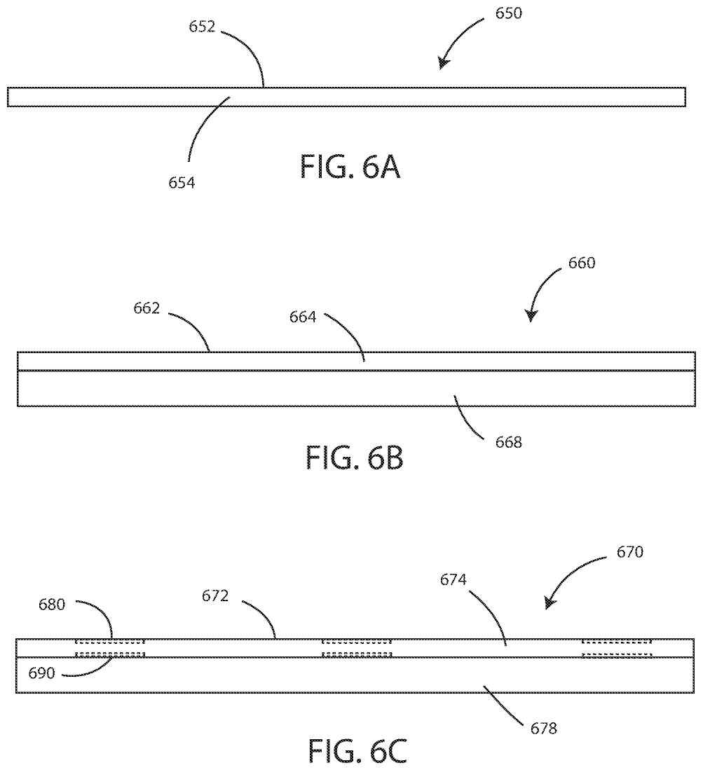

In order to obtain desired properties, including thermal performance, adhesion and release of build and support materials, physical support of the weight of the part and pressure from the transfusion process, various single and multi-layer constructions can be used for the build substrate. FIG. 6A is a cross section of a first build substrate 650 for STEP additive manufacturing process, showing a single layer 654 of substrate material, with top surface 652. This single layer 654 can be, for example, a layer of F4-4 material. FIG. 6B is a cross section of a second build substrate 660 for STEP additive manufacturing process, showing a two-layer construction. The two-layer construction includes a top layer 664 with top surface 662, plus a bottom layer 668. The top layer can be, for example F4-4 material, with a different support underneath it forming bottom layer 668 (such as a reinforced resin, a molded plastic, a metal, etc.). FIG. 6C is a cross section of a third build substrate 670 for STEP additive manufacturing process, also showing a two-layer construction but with conductive tracings 680 and 690 along with top layer 674 and bottom layer 678. Conductive tracings 680 are shown near the top surface 672 of the top layer 674; while regions for temperature sensors 690 are shown between the top layer 674 and bottom layer 678. These regions of conductive tracings 680, 690 are shown as general example locations, and it will be appreciated that typically the temperature sensors are quit thin, and can be located at various positions, including near the surface 672, deeper into the substrate 670, or both. There is some benefit in having sensors at multiple depths so as to measure flow of heat through the build substrate 670. Also, the build substrate can include one or more pressure sensors, shear force sensors, accelerometers, capacitive sensors, or combinations thereof In some constructions the substrate is two-parts: a) a top removable portion containing a surface for deposition of build material and containing sensors; and b) a base portion configured to receive the top removable portion, the base portion having electrical connectors to the top portion, and also optionally containing an embedded processor, power source, cooling, wireless communication capability, and combinations thereof.

The thermal properties of the build substrate are often quite important and can be selected and customized for various materials and uses. In an example embodiment a build substrate for use in a STEP additive manufacturing system includes a surface for receiving a build material deposited by a STEP process wherein the platform has selected thermal properties within 30 percent of the build material to be deposited onto the platform. In some constructions the platform has selected thermal properties within 20 percent of the build material to be deposited onto the platform. In various constructions the platform has selected thermal properties within 10 percent of the build material to be deposited onto the platform.

The build substrate can be selected on the basis of heat absorption, and in some constructions has a heat absorption rate within 30 percent of a partially completed part formed of the build material. The build substrate can also be selected on the basis of heat capacity Cp, and in example embodiments the build substrate has a heat capacity Cp within 30 percent of a partially completed part formed of the build material. The build substrate can also be picked to on the basis of thermal diffusivity K, and in an example embodiment the build substrate has a thermal diffusivity K within 30 percent of a partially completed part formed of the build material. The build substrate can be based upon thermal conductivity K, and in an example embodiment has a thermal conductivity K within 30 percent of a partially completed part formed of the build material. In certain constructions the thermal conductivity K is within 28 to 32 percent of a partially completed part formed of the build material. In certain constructions the thermal conductivity K is within 26 to 34 percent of a partially completed part formed of the build material. In certain constructions the thermal conductivity K is within 25 to 35 percent of a partially completed part formed of the build material. In certain constructions the thermal conductivity K is within 20 to 40 percent of a partially completed part formed of the build material.

In an example embodiment the thickness of the build substrate is within at least three thermal diffusion lengths at the layer rate of the STEP process. In an example embodiment the build substrate is within at least two thermal diffusion lengths at the layer rate of the STEP process. In an example embodiment the build substrate is within at least one thermal diffusion lengths at the layer rate of the STEP process. In an example embodiment the build substrate is within at least four thermal diffusion lengths at the layer rate of the STEP process.

In some constructions the build substrate is constructed such that fraction η of the pre-heat illumination absorbed by the build substrate is within 20 percent of the fraction η of pre-heat illumination absorbed by the build material. In some constructions the build substrate is constructed such that fraction η of the pre-heat illumination absorbed by the build substrate is within 25 percent of the fraction η of pre-heat illumination absorbed by the build material. In some constructions the build substrate is constructed such that the pre-heat illumination η absorbed by the build substrate is within 15 percent of the pre-heat illumination η absorbed by the build material. In some constructions the build substrate is constructed such that the pre-heat illumination η absorbed by the build substrate is within 10 percent of the pre-heat illumination η absorbed by the build material.

In some embodiments the thermal expansion coefficient (TEC) of the build substrate is at least 50 um/(m deg C.) different than the thermal expansion coefficient (TEC) of the build material. In some embodiments the thermal expansion coefficient (TEC) of the build substrate is at least 60 um/(m deg C.) different than the thermal expansion coefficient (TEC) of the build material. In some embodiments the thermal expansion coefficient (TEC) of the build substrate is at least 40 um/(m deg C.) different than the thermal expansion coefficient (TEC) of the build material. In some embodiments the thermal expansion coefficient (TEC) of the build substrate is at least 30 um/(m deg C.) different than the thermal expansion coefficient (TEC) of the build material. In some embodiments the thermal expansion coefficient (TEC) of the build substrates is at least 25 um/(m deg C.) different than the thermal expansion coefficient (TEC) of the build material. In some embodiments the thermal expansion coefficient (TEC) of the build substrate is at least 10 um/(m deg C.) different than the thermal expansion coefficient (TEC) of the build material.

In some embodiments the thermal expansion coefficient (TEC) of the build substrate less than 50 um/(m deg C.) different than the thermal expansion coefficient (TEC) of the build material. In some embodiments the thermal expansion coefficient (TEC) of the build substrate is less than 60 um/(m deg C.) different than the thermal expansion coefficient (TEC) of the build material. In some embodiments the thermal expansion coefficient (TEC) of the build substrate is less than 40 um/(m deg C.) different than the thermal expansion coefficient (TEC) of the build material. In some embodiments the thermal expansion coefficient (TEC) of the build substrate is at least 30 um/(m deg C.) different than the thermal expansion coefficient (TEC) of the build material. In some embodiments the thermal expansion coefficient (TEC) of the build substrates is less than 25 um/(m deg C.) different than the thermal expansion coefficient (TEC) of the build material. In some embodiments the thermal expansion coefficient (TEC) of the build substrate is less than 10 um/(m deg C.) different than the thermal expansion coefficient (TEC) of the build material.

Optionally the build substrate can include one or more temperature sensors in the surface of the build substrate. Such temperature sensors can be, for example, thin conductive traces, such as copper traces. The temperature can be measured, for example, by resistance using a wheatstone bridge. In some embodiments the temperature response of the temperature sensor or sensors is within 1 msec, in others within 2 msec., and in others within 5 msec.

In typical embodiments the substrate has a thickness of at least the bulk temperature depth. For example, in some constructions the substrate has a thickness of at least 63 mils. In typical embodiments the substrate has a thickness of at least the bulk temperature depth. For example, in some constructions the substrate has a thickness of at least 100 mils. In typical embodiments the substrate has a thickness of at least the bulk temperature depth. For example, in some constructions the substrate has a thickness of at least 150 mils. In typical embodiments the substrate has a thickness of at least the bulk temperature depth. For example, in some constructions the substrate has a thickness of at least 200 mils. In typical embodiments the substrate has a thickness of at least the bulk temperature depth. For example, in some constructions the substrate has a thickness of at least 25-mils.

An aspect of the present disclosure is directed to an additive manufacturing system for creating a 3D part, in particular a selective toner electrophotographic process (STEP) additive manufacturing. In an example implementation the additive manufacturing system includes an imaging engine configured to develop an imaged layer of a thermoplastic-based powder, a movable build platform, and a transfer medium (e.g., a rotatable belt or drum) configured to receive the imaged layer from the imaging engine and to convey the received imaged layer to the build substrate on the build platform, where multiple imaged layers are built up to form a 3D part. The system also includes a transfusion assembly configured to transfer the heated imaged layer conveyed by the transfer medium onto the movable build platform by pressing the heated imaged layer between the transfer medium and the moveable build platform, and a cooling unit configured to actively cool the transferred layer.

In a certain embodiment a build substrate for use in a STEP additive manufacturing system includes a platform for receiving a build material deposited by a STEP process wherein the platform has selected thermal properties within 30 percent of the build material to be deposited onto the platform. In some constructions the platform has selected thermal properties within 20 percent of the build material to be deposited onto the platform. In various constructions the platform has selected thermal properties within 10 percent of the build material to be deposited onto the platform.

The build substrate can be selected on the basis of heat absorption, and in some constructions has a heat absorption rate within 30 percent of a partially completed part formed of the build material. The build substrate can also be selected on the basis of heat capacity Cp, and in example embodiments the build substrate has a heat capacity Cp within 30 percent of a partially completed part formed of the build material. The build substrate can also be picked to on the basis of thermal diffusivity K, and in an example embodiment the build substrate has a thermal diffusivity K within 30 percent of a partially completed part formed of the build material. The build substrate can be based upon thermal conductivity K, and in an example embodiment has a thermal conductivity K within 30 percent of a partially completed part formed of the build material.

In some embodiments the thermal expansion coefficient (TEC) of the build substrate is at least 50 um/(m deg C.) different than the thermal expansion coefficient (TEC) of the build material.

Optionally the build substrate can include one or more temperature sensors in the surface of the build substrate. Such temperature sensors can be, for example, thin conductive traces, such as copper traces. The temperature can be measured, for example, by resistance using a wheatstone bridge.

A method for building an article using a selective toner electrophotographic process (STEP) additive manufacturing system is also disclosed, the method comprising providing the build substrate having a platform for receiving a build material deposited by a STEP process; wherein the platform has selected thermal properties within 30 percent of the build material to be deposited onto the platform; and building an article on the build substrate while controlling the thermal properties of the build substrate.

It should be noted that, as used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

The terms “about” and “substantially” are used herein with respect to measurable values and ranges due to expected variations known to those skilled in the art (e.g., limitations and variabilities in measurements).

It should also be noted that, as used in this specification and the appended claims, the phrase “configured” describes a system, apparatus, or other structure that is constructed or configured to perform a particular task or adopt a particular configuration. The phrase “configured” can be used interchangeably with other similar phrases such as arranged and configured, constructed and arranged, constructed, manufactured and arranged, and the like.

The terms “transfusion”, “transfuse”, “transfusing”, and the like refer to the adhesion of layers with the use of heat and pressure, where polymer molecules of the layers at least partially interdiffuse.

The term “transfusion pressure” refers to a pressure applied during a transfusion step, such as when transfusing layers of a 3D part together.

The term “deformation temperature” of a 3D part refers to a temperature at which the 3D part softens enough such that a subsequently-applied transfusion pressure, such as during a subsequent transfusion step, overcomes the structural integrity of the 3D part, thereby deforming the 3D part.

Directional orientations such as “above”, “below”, “top”, “bottom”, and the like are made with reference to a direction along a printing axis of a 3D pan, In the embodiments in which the printing axis is a vertical z-axis, the layer-printing direction is the upward direction along the vertical z-axis. In these embodiments, the terms “above”, “below”, “top”, “bottom”, and the like are based on the vertical z-axis. However, in embodiments in which the layers of 3D parts are printed along a different axis, the terms “above”, “below”, “top”, “bottom”, and the like are relative to the given axis.

The term “providing”, such as for “providing a material” and the like, when recited in the claims, is not intended to require any particular delivery or receipt of the provided item. Rather, the term “providing” is merely used to recite items that will be referred to in subsequent elements of the claim(s), for purposes of clarity and ease of readability

All publications and patent applications in this specification are indicative of the level of ordinary skill in the art to which this invention pertains. All publications and patent applications are herein incorporated by reference to the same extent as if each individual publication or patent application was specifically and individually indicated by reference.

The embodiments described herein are not intended to be exhaustive or to limit the invention to the precise forms disclosed in the following detailed description. Rather, the embodiments are chosen and described so that others skilled in the art can appreciate and understand the principles and practices. As such, aspects have been described with reference to various specific and preferred embodiments and techniques. However, it should be understood that many variations and modifications may be made while remaining within the spirit and scope herein.

1. A build platform for use in a selective toner electrophotographic process (STEP) additive manufacturing system, the build platform comprising:
a build substrate for receiving a build material deposited by a STEP process;
wherein the substrate has selected thermal properties within 30 percent of the build material to be deposited onto the platform.

2. The build platform of claim 1, wherein the build substrate has selected thermal properties within 20 percent of the build material to be deposited onto the platform.

3. The build platform of claim 1, wherein the build substrate has selected thermal properties within 10 percent of the build material to be deposited onto the platform.

4. The build platform of claim 1, wherein the build substrate platform comprises a glass-reinforced epoxy laminate material.

5. The build platform of claim 1, wherein the build substrate comprises National Electrical Manufacturers Association (NEMA) FR-4 material.

6. The build platform of claim 1, wherein the build substrate has a heat absorption rate within 30 percent of a partially completed part formed of the build material or support material.

7. The build platform of claim 1, wherein the build substrate has a heat capacity Cp within 30 percent of a partially completed part formed of the build material.

8. The build platform of claim 1, wherein the build substrate has a thermal diffusivity K within 30 percent of a partially completed part formed of the build material.

9. The build platform of claim 1, wherein the build substrate has a thermal conductivity K within 30 percent of a partially completed part formed of the build material.

10. The build platform of claim 1, wherein the thickness of the build substrate is within at least three thermal diffusion lengths at the layer rate of the STEP process.

11. The build platform of claim 1, wherein the fraction η of pre-heat illumination absorbed by the build substrate is within 20 percent of the fraction η of pre-heat illumination absorbed by the build material.

12. The build platform of claim 1, wherein the thermal expansion coefficient (TEC) of the build substrate is at least 50 um/(m deg C.) different than the thermal expansion coefficient (TEC) of the build material.

13. The build platform of claim 1, further comprising temperature sensor in the surface of the build substrate.

14-15. (canceled)

16. The build platform of claim 13, wherein temperature is measured by resistance using a wheatstone bridge.

17. The build platform of claim 13, wherein the temperature response is within 1 msec.

18. The build platform of claim 1, further comprising an embedded processor, power source, cooling, wireless communication capability, and combinations thereof

19. The build platform of claim 1, wherein the substrate has a thickness of at least the bulk temperature depth.

20. (canceled)

21. The build platform of claim 1, further comprising a pressure sensor, shear force sensor, accelerometer, capacitive sensor, or combination thereof

22. The build platform of claim 1, wherein the substrate is two-parts:
a) a top removable portion containing a surface for deposition of build material and containing sensors; and
b) a base portion configured to receive the top removable portion, the base portion having electrical connectors to the top portion, and also optionally containing an embedded processor, power source, cooling, wireless communication capability, and combinations thereof

23. A method for building an article using a selective toner electrophotographic process (STEP) additive manufacturing system, the method comprising:
providing a build platform having a substrate for receiving a build material deposited by a STEP process; wherein the build substrate has selected thermal properties within 30 percent of the build material to be deposited onto the platform; and
building an article on the build substrate while controlling the thermal properties of the build substrate.
